(19) United States
(12) Patent Application Publication
(10) Pub. No.: US 2025/0157457 A1
(43) Pub. Date: May 15, 2025

(54) METHOD OF TRAINING DEEP LEARNING MODEL, AND METHOD OF SYNTHESIZING SPEECH

(71) Applicant: Beijing Baidu Netcom Science Technology Co., Ltd., Beijing (CN)

(72) Inventors: Bin HUANG, Beijing (CN); Tao SUN, Beijing (CN); Ce ZHANG, Beijing (CN); Yongguo KANG, Beijing (CN); Xiaoyin FU, Beijing (CN); Lei JIA, Beijing (CN)

(21) Appl. No.: 19/023,572

(22) Filed: Jan. 16, 2025

(30) Foreign Application Priority Data
Mar. 20, 2024 (CN) 202410323954.X

(51) Int. Cl. G10L 13/027

(52) U.S. Cl. CPC G10L 13/027

(57) ABSTRACT

A method of training a deep learning model and a method of synthesizing a speech are provided, which relate to a field of artificial intelligence technology, in particular to fields of large model, large language model, generative model, deep learning, and speech processing technologies. The method of training a deep learning model includes: determining a reference speech feature of a sample speech, the reference speech feature being associated with a prosodic feature of the sample speech; retrieving a speech library using a sample text corresponding to the sample speech, so as to obtain a pronunciation expression feature of the sample text; inputting the pronunciation expression feature into the deep learning model to obtain an output speech feature; determining a loss of the deep learning model according to the reference speech feature and the output speech feature; and adjusting a parameter of the deep learning model according to the loss.

This application claims the benefit of priority to Chinese Patent Application No. 202410323954.X, filed on Mar. 20, 2024. The entire contents of this application are hereby incorporated herein by reference.

### TECHNICAL FIELD

The present disclosure relates to a field of artificial intelligence technology, in particular to fields of large model, large language model, generative model, deep learning, and speech processing technologies. More specifically, the present disclosure provides a method of training a deep learning model, a method of synthesizing a speech, another method of training a deep learning model, an electronic device, and a storage medium.

### BACKGROUND

A speech synthesis refers to a process of converting a text into a speech. After the speech synthesis entered the era of deep learning, an effect of the speech synthesis has been significantly improved. However, the current training of end-to-end speech synthesis model has reached an upper limit in terms of data utilization. For example, synthetic data is still limited to the level of hundreds or thousands of hours, and an increase of the amount of training data may not improve the performance of the model.

### SUMMARY

The present disclosure provides a method of training a deep learning model, a method of synthesizing a speech, another method of training a deep learning model, an electronic device, and a storage medium.

According to a first aspect, a method of training a deep learning model is provided, including: determining a reference speech feature of a sample speech, where the reference speech feature is associated with a prosodic feature of the sample speech; retrieving a speech library using a sample text corresponding to the sample speech, so as to obtain a pronunciation expression feature of the sample text; inputting the pronunciation expression feature into the deep learning model to obtain an output speech feature; determining a loss of the deep learning model according to the reference speech feature and the output speech feature; and adjusting a parameter of the deep learning model according to the loss.

According to a second aspect, a method of synthesizing a speech is provided, including: retrieving, from a speech library, a pronunciation expression feature of a text to be synthesized by using the text to be synthesized; inputting the pronunciation expression feature into a deep learning model to obtain an output speech feature, where the deep learning model is trained according to the above-mentioned method of training the deep learning model; and generating a synthesized speech for the text to be synthesized according to the output speech feature.

According to a third aspect, a method of training a deep learning model is provided, including: determining, from a speech library, a sample speech and a sample text corresponding to the sample speech; retrieving, from remaining speeches other than the sample speech in the speech library, a pronunciation expression feature of the sample text based on the sample text by using the deep learning model; determining a loss of the deep learning model according to a speech feature of the sample speech and the pronunciation expression feature of the sample text; and adjusting a parameter of the deep learning model according to the loss.

According to a fourth aspect, an electronic device is provided, including: at least one processor; and a memory communicatively connected to the at least one processor, where the memory stores instructions executable by the at least one processor, and the instructions, when executed by the at least one processor, are configured to cause the at least one processor to implement the methods provided according to the present disclosure.

According to a fifth aspect, a non-transitory computer-readable storage medium having computer instructions therein is provided, where the computer instructions are configured to cause a computer to implement the methods provided according to the present disclosure.

It should be understood that content described in this section is not intended to identify key or important feature in embodiments of the present disclosure, nor is it intended to limit the scope of the present disclosure. Other feature of the present disclosure will be easily understood through the following description.

### BRIEF DESCRIPTION OF THE DRAWINGS

The accompanying drawings are used for better understanding of the solution and do not constitute a limitation to the present disclosure. In the accompanying drawings:

FIG. 1 shows a schematic diagram of an exemplary system architecture to which at least one of a method of training a deep learning model, a method of synthesizing a speech, or another method of training a deep learning model may be applied according to an embodiment of the present disclosure;

FIG. 2 shows a flowchart of a method of training a deep learning model according to an embodiment of the present disclosure;

FIG. 3 shows a schematic diagram of a method of training a deep learning model according to an embodiment of the present disclosure;

FIG. 4 shows a schematic diagram of a method of determining a reference speech feature using a speech synthesis model according to an embodiment of the present disclosure;

FIG. 5 shows a schematic diagram of a method of retrieving a pronunciation expression feature using a speech retrieval model according to an embodiment of the present disclosure;

FIG. 6 shows a schematic diagram of a method of training a deep learning model according to an embodiment of the present disclosure;

FIG. 7 shows a flowchart of a method of synthesizing a speech according to an embodiment of the present disclosure;

FIG. 8 shows a flowchart of a method of training a deep learning model according to another embodiment of the present disclosure;

FIG. 9 shows a schematic diagram of a method of synthesizing a speech according to an embodiment of the present disclosure;

FIG. 10 shows a block diagram of an apparatus of training a deep learning model according to an embodiment of the present disclosure;

FIG. 11 shows a block diagram of an apparatus of synthesizing a speech according to an embodiment of the present disclosure;

FIG. 12 shows a block diagram of an apparatus of training a deep learning model according to another embodiment of the present disclosure; and

FIG. 13 shows a block diagram of an electronic device for implementing at least one of a method of training a deep learning model, a method of synthesizing a speech, or another method of training a deep learning model according to an embodiment of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as just exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

With a flourishing development of large models, a speech synthesis technology has also entered the era of large models. A large model-based speech synthesis has put forward higher requirements for synthesis effects, for example, to be comparable to or even surpass a real person.

At present, an existing solution of large model speech synthesis technology is to discretize a speech feature into a plurality of codebooks through a pre-trained large language model, and then model these discrete codebooks based on a large language model modeling technology, which may bring a great improvement of the synthesis effect after the data is expanded to the level of tens of thousands of hours.

However, when utilizing big data modeling to improve synthesis effect, the current large model speech synthesis technology also introduced some problems. Firstly, the synthesis effect is unstable, and it is prone to problems such as missing words, repetition, muteness, and abnormal prosody. Secondly, it is impossible to continuously increase data to improve the effect, because the training of big data models requires a large amount of computing power, and it is impossible to continuously improve the effect through continuous training. When obtaining new data, retraining may cause significant training costs. Thirdly, in a practical synthesis application, when it is needed to synthesize a speech of a specific person, it is necessary to provide a speech of the specific person as a prompt speech. The prompt speech may need to have a high quality, so only a limited number of speeches of the specific person, generally a few sentences to dozens of sentences, may be used as the prompt speech, which may not support a synthesis effect of generating a speech with a speaker feature.

Therefore, the current large model speech synthesis technology has an unstable synthesis effect, which has a large gap compared to real person especially in terms of prosodic fluctuations.

In technical solutions of the present disclosure, a collection, a storage, a use, a processing, a transmission, a provision, a disclosure and other processing of user personal information involved comply with provisions of relevant laws and regulations and do not violate public order and good custom.

In the technical solutions of the present disclosure, the acquisition or collection of user personal information has been authorized or allowed by users.

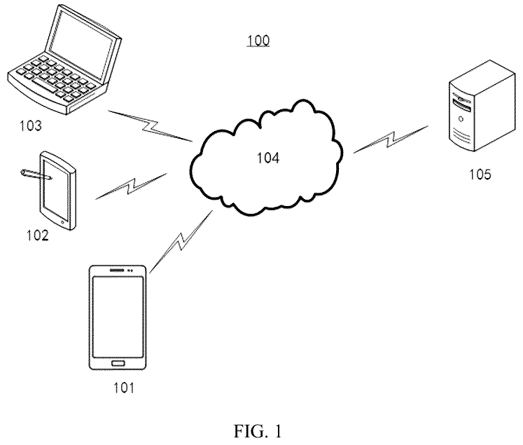

FIG. 1 shows a schematic diagram of an exemplary system architecture to which a method of training a deep learning model and/or a method of synthesizing a speech may be applied according to an embodiment of the present disclosure. It should be noted that FIG. 1 only shows an example of the system architecture to which embodiments of the present disclosure may be applied, so as to help those skilled in the art understand technical contents of the present disclosure. However, it does not mean that embodiments of the present disclosure may not be applied to other devices, systems, environments or scenarios.

As shown in FIG. 1, a system architecture 100 according to such embodiments may include terminal devices 101, 102 and 103, a network 104, and a server 105. The network 104 is a medium for providing a communication link between the terminal devices 101, 102, 103 and the server 105. The network 104 may include various connection types, such as wired and/or wireless communication links, etc.

The terminal devices 101, 102 and 103 may be used by a user to interact with the server 105 through the network 104 to receive or send messages, etc. The terminal devices 101, 102 and 103 may be various electronic devices, including but not limited to smart phones, tablet computers, and laptop computers, etc.

The method of training the deep learning model provided in embodiments of the present disclosure may generally be performed by the server 105. Accordingly, the apparatus of training the deep learning model provided in embodiments of the present disclosure may generally be arranged in the server 105.

The method of synthesizing the speech provided in embodiments of the present disclosure may generally be performed by the terminal devices 101, 102 and 103. Accordingly, the apparatus of synthesizing the speech provided in embodiments of the present disclosure may generally be arranged in the terminal devices 101, 102 and 103.

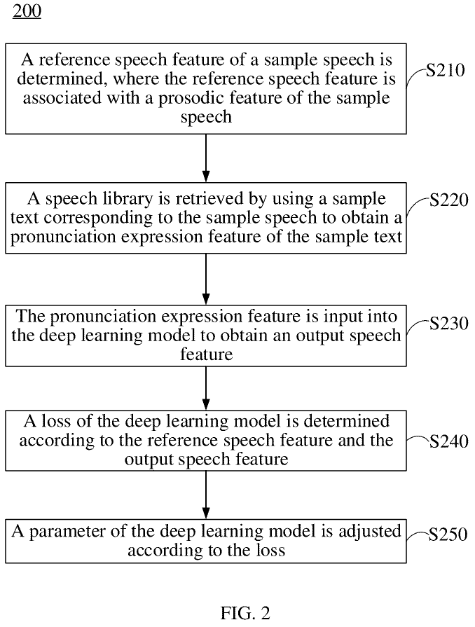

FIG. 2 shows a flowchart of a method of training a deep learning model according to an embodiment of the present disclosure.

According to embodiments of the present disclosure, a reference speech feature of a sample speech is determined, a pronunciation expression feature of a sample text corresponding to the sample speech is retrieved from a speech library, the pronunciation expression feature is input into a deep learning model to obtain an output speech feature, and a parameter of a large language model is adjusted based on a difference between the reference speech feature and the output speech feature. The reference speech feature is used to reconstruct a speech, and the deep learning model trained under the supervision of the reference speech feature may have an ability of speech synthesis.

According to embodiments of the present disclosure, the reference speech feature is associated with a prosodic feature. By training the deep learning model under the supervision of the reference speech feature, it is possible to improve a prosodic fluctuation effect of the speech synthesis of the trained deep learning model, avoid the problems of prosodic abnormalities such as missing words, repetition, muteness, etc. in the synthesized speech, and improve the stability of speech synthesis.

As shown in FIG. 2, a method 200 of training a deep learning model includes operation S210 to operation S250.

In operation S210, a reference speech feature of a sample speech is determined. The reference speech feature is associated with a prosodic feature of the sample speech.

In such embodiments, the sample speech is used to train the deep learning model, and the deep learning model may be a model used to execute speech synthesis tasks. The reference speech feature of the sample speech may be a feature used to reconstruct the sample speech.

The reference speech feature may be the prosodic feature and/or a Mel spectrum feature of the sample speech. The prosodic feature is determined according to the sample speech and a text of the sample speech, and the Mel spectrum feature of the sample speech is determined according to the prosodic feature. The prosodic feature of the sample speech may be converted into the Mel spectrum feature of the sample speech, and the Mel spectrum feature of the sample speech may be directly converted into the sample speech. Therefore, the prosodic feature and the Mel spectrum feature may be used for the reconstruction of the sample speech. As the reference speech feature is associated with the prosodic feature, the reference speech feature may also be used to reconstruct the sample speech.

The text of the sample speech is used as the sample text, and the prosodic feature is determined from a timbre of the sample speech and a text feature of the sample text. Therefore, the prosodic feature includes a timbre information, a text content information, and a prosodic information of a pronunciation expression. In an example, the prosodic feature of the sample speech may be used as the reference speech feature for the training of the deep learning model, which may reduce a prosodic gap between the synthesized speech of the deep learning model and the real person speech, and improve a simulation and reality of the synthesized speech, so that the synthesized speech may be closer to a real person.

In another example, the Mel spectrum feature of the sample speech may be used as the reference speech feature. In still another example, a combination of the prosodic feature of the sample speech and the Mel spectrum feature of the sample speech may be used as the reference speech feature.

In operation S220, a speech library is retrieved by using a sample text corresponding to the sample speech to obtain a pronunciation expression feature of the sample text.

For example, the speech library may be a database that contains historical speeches of the same speaker, or a database that contains historical speeches of a plurality of speakers. In an example, if a speech synthesis task is to synthesize a speech with a timbre of a specific person, the speech library may be a database that contains the historical speeches of the specific person.

For example, the speech library may contain a large number of historical sentences. If the sample text is contained in the speech library, the pronunciation expression feature of the sample text may be retrieved directly from the speech library. If the sample text is not contained in the speech library, it is possible to retrieve the pronunciation expression feature of each word of the sample text from the speech library, and then concatenate the pronunciation expression features of the words together to obtain the pronunciation expression feature of the sample text. The above-mentioned pronunciation expression feature may include a prosodic fluctuation pattern of pronunciation.

In operation S230, the pronunciation expression feature is input into a deep learning model to obtain an output speech feature.

The deep learning model may be a large language model, and the above-mentioned pronunciation expression feature may be used as a prompt information of the large language model to prompt the large language model to output an output speech feature corresponding to the pronunciation expression pattern. The output speech feature is used for speech synthesis.

Embodiments of the present disclosure may be implemented to generate an output speech feature based on the pronunciation expression feature by using the large language model and synthesize a speech based on the output speech feature, which may improve an accuracy of speech synthesis and a stability of prosodic fluctuations compared with synthesizing a speech directly based on a text using a large language model.

In operation S240, a loss of the deep learning model is determined according to the reference speech feature and the output speech feature.

In operation S250, a parameter of the deep learning model is adjusted according to the loss.

The reference speech feature is a feature that may be used to reconstruct the sample speech, and a purpose of the model training is to synthesize a sample speech for the sample text. Therefore, the output speech feature generated by the model needs to be consistent with the reference speech, so that the sample speech may be reconstructed based on the output speech feature. Therefore, the deep learning model may be trained under the supervision of the reference speech feature, and the loss of the model training may be a difference between the output speech feature and the reference speech feature.

It is possible to calculate a cross entropy, a mean square error or other differences between the output speech feature and the reference speech feature as the loss of the deep learning model, and adjust the parameter of the deep learning model according to the loss, so as obtain a trained deep learning model.

The pronunciation expression feature may be input into the trained deep learning model, and an output speech feature may be output. As a training goal of the model in a training stage is that the output speech feature is consistent with the reference speech feature, the trained deep learning model is equivalent to establishing a mapping relationship between the pronunciation expression feature and the reference speech feature. Therefore, for a new text, after the pronunciation expression feature of the new text is obtained, the trained deep learning model may be used to generate a corresponding reference speech feature based on the pronunciation expression feature, convert the reference speech feature into a Mel spectrum feature, and convert the Mel spectrum feature into a speech for the new text, so as to achieve a speech synthesis.

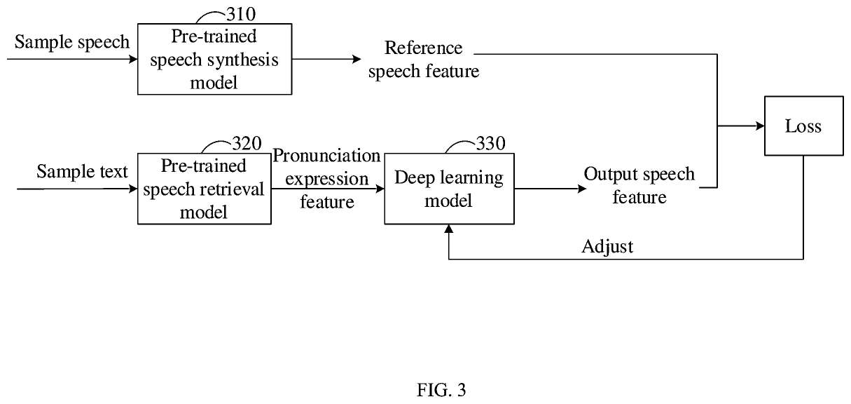

FIG. 3 shows a schematic diagram of a method of training a deep learning model according to an embodiment of the present disclosure.

As shown in FIG. 3, the reference speech feature may be obtained using a pre-trained speech synthesis model 310. The pronunciation expression feature may be obtained using a pre-trained speech retrieval model 320. A deep learning model 330 may be trained using the pronunciation expression feature and the reference speech feature.

For example, the sample speech may be input into the pre-trained speech synthesis model 310 to obtain the reference speech feature. The pre-trained speech synthesis model 310 may be an end-to-end speech synthesis model. The speech synthesis model may encode the sample speech and the text for the sample speech to obtain a timbre feature and a text feature, respectively, encode the timbre feature and the text feature to obtain a prosodic feature, and then encode the prosodic feature to obtain a Mel spectrum feature. In the above-mentioned process, at least one of the prosodic feature or the Mel spectrum feature may be used as the reference speech feature.

For example, the sample text is a text corresponding to the sample speech. The sample text may be input into the pre-trained speech retrieval model 320 to obtain a pronunciation expression feature. The pre-trained speech retrieval model 320 may be trained based on the speech library. When retrieving the sample text using the speech retrieval model 320, it is possible to calculate a cross-attention feature between the sample text and a speech feature in the speech library, and generate a Mel spectrum feature of the sample text based on the cross-attention feature. In the above-mentioned process, at least one of the attention feature or the Mel spectrum feature may be used as the pronunciation expression feature.

The pronunciation expression feature may be input into the deep learning model 330 to obtain an output speech feature. A difference between the output speech feature and the reference speech feature may be calculated to obtain a loss of the deep learning model, and the parameter of the deep learning model 330 may be adjusted according to the loss. By training the deep learning model 330 under the supervision of the reference speech feature, the trained deep learning model 330 may establish a mapping relationship between the pronunciation expression feature and the reference speech feature. That is, the input of the trained deep learning model is the pronunciation expression feature, and the output is an output speech feature consistent with the reference speech feature.

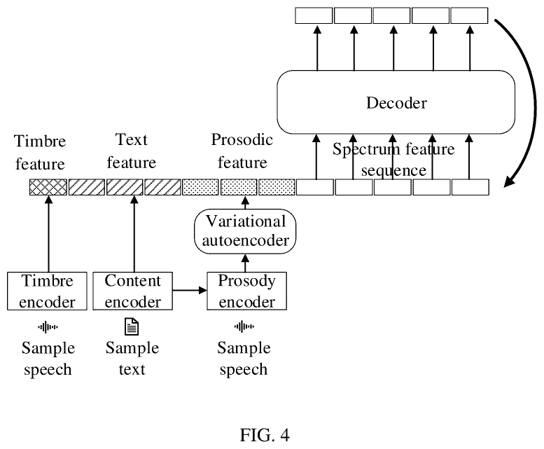

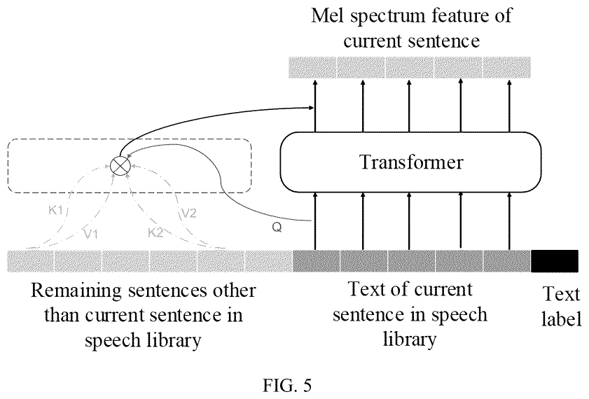

The speech synthesis model and the speech retrieval model provided in the present disclosure will be described below with reference to FIG. 4 and FIG. 5, respectively.

FIG. 4 shows a schematic diagram of a method of determining a reference speech feature using a speech synthesis model according to an embodiment of the present disclosure.

As shown in FIG. 4, the speech synthesis model may include a plurality of encoders and a backbone decoder. The plurality of encoders include a timbre encoder, a content encoder, a prosody encoder, and a variational autoencoder.

According to embodiments of the present disclosure, determining the reference speech feature may include: determining a timbre feature of a sample speech; determining a text feature of a sample text; determining a prosodic feature of the sample text according to the timbre feature and the text feature; determining a Mel spectrum feature of the sample speech according to the timbre feature, the text feature and the prosodic feature; and determining at least one of the prosodic feature or the Mel spectrum feature as the reference speech feature.

The sample speech may be input into the timbre encoder to obtain a sentence-level timbre feature, and the timbre feature represents a speaker feature. The sample text corresponding to the sample speech may be input into the content encoder to obtain a text feature at phoneme granularity. The sample speech and the sample text may be input into the prosodic encoder to obtain a prosodic information at phoneme or state granularity. The prosodic information may be input into the variational autoencoder to obtain a discrete prosodic feature. The variational autoencoder may be VQ-VAE (Vector Quantized-Variational AutoEncoder).

The timbre feature, the text feature and the prosodic feature may be input into the decoder to obtain a spectrum feature sequence, i.e., Mel spectrum feature sequence. The decoder may be a Transformer based autoregressive model.

The above-mentioned speech synthesis model may be trained based on a dataset of finely-labeled samples. A finely-labeled sample refers to a sample speech labeled with a corresponding sample text, and the sample speech has a high quality, for example, the sample speech has clear pronunciation, no missing words, no repetition, and no muteness. Accordingly, the sample text also has a high quality, without missing words, repetition, etc.

In the training stage of the above-mentioned speech synthesis model, the timbre feature, the text feature and the prosodic feature output by the plurality of encoders are used as input conditions and input into the backbone decoder. The backbone decoder may output the Mel spectrum feature sequence based on the input conditions. An actual Mel spectrum feature sequence of the sample speech may be determined, and a difference between the actual Mel spectrum feature sequence and the Mel spectrum feature sequence output by the decoder may be calculated as a loss of the speech synthesis model. The parameters of the encoders and the decoder in the speech synthesis model may be adjusted according to the loss, so as to obtain a trained speech synthesis model.

The above-mentioned trained speech synthesis model may be used to synthesize a speech in an application stage. For example, a text to be synthesized may be input into the trained speech synthesis model to obtain a Mel spectrum feature sequence. The Mel spectrum feature sequence may be converted into a speech, so as to obtain a synthesized speech for the text to be synthesized.

The above-mentioned trained speech synthesis model may be used to reconstruct a spectrum feature in the application stage. For example, a speech for which a spectrum feature is to be reconstructed may be input into the trained speech synthesis model to obtain an intermediate prosodic feature and a Mel spectrum feature sequence. In embodiments of the present disclosure, the ability of the speech synthesis model to reconstruct a spectrum feature may be utilized, and at least one of the prosodic feature or the Mel spectrum feature sequence generated in the process of reconstructing the spectrum feature may be used as the reference speech feature for the training of the deep learning model.

Embodiments of the present disclosure may be implemented to encode using the timbre encoder and the prosodic encoder to obtain the timbre feature and the prosodic feature respectively, so that decoupling of the speaker feature and the prosodic feature may be achieved, and the accuracy of the reference speech feature may be improved.

FIG. 5 shows a schematic diagram of a method of retrieving a pronunciation expression feature using a speech retrieval model according to an embodiment of the present disclosure.

As shown in FIG. 5, the speech retrieval model may be a Transformer based model. The speech retrieval model may be trained based on the speech library. The speech in the speech library may be coarsely-labeled speech data, which means low quality requirements for the speech in the speech library, allowing for unclear pronunciation, missing words, repeated words, etc. Accordingly, the quality requirements for a text label are not high, allowing for missing words, repetition, etc. For example, the coarsely-labeled speech may be obtained from a public network.

Speeches in the speech library may come from the same speaker or from different speakers. When the speech synthesis task is to synthesize a speech of a specific person, the speeches in the speech library coming from the specific person may result in a better effect of the speech synthesis.

In the training stage of the above-mentioned speech retrieval model, each sentence of speech in the speech library may be used to train the speech retrieval model. For example, for each sentence of speech (current sentence) in the speech library, during training, the current sentence may be removed from a retrieval range of the speech library; with a text of the current sentence as query sentence (Query), and with remaining sentences of speech other than the current sentence in the speech library as Key and Value, a retrieval may be performed based on the Key and the Value by using the text (Query) of the current sentence, so as to obtain an attention feature between the text feature of the text of the current sentence and the speech feature of the remaining sentences of speech. A Mel spectrum feature may be obtained based on the attention feature. In the above-mentioned retrieval process, a retrieval unit may be a phoneme or syllable, and at least one of the attention feature or the Mel spectrum feature may be used as the pronunciation expression feature.

In an example, a difference between the retrieved Mel spectrum feature and a real Mel spectrum feature of the current sentence may be calculated as a loss of the current sentence, and a total loss may be determined according to losses of all sentences in the speech library. A parameter of the speech retrieval model may be adjusted according to the total loss, so as to obtain a trained speech retrieval model.

The above-mentioned trained speech retrieval model may be used to retrieve the pronunciation expression feature of the text to be synthesized in the application stage. For example, the text to be synthesized may be input into the trained speech retrieval model. The speech retrieval model may retrieve the speech feature in the speech library based on the text to be synthesized so as to obtain an attention feature between the text feature of the text to be synthesized and the speech feature in the speech library, and obtain a Mel spectrum feature based on the attention feature. At least one of the attention feature or the Mel spectrum feature may be used as the pronunciation expression feature of the text to be synthesized for the training of the deep learning model.

In the training stage of the speech retrieval model of embodiments of the present disclosure, for each sentence of speech, that sentence of speech may be removed from the retrieval range during training, and the speech retrieval model is forced to learn to reconstruct the speech feature of the current sentence from the remaining sentences in the speech library, so that the model may have the ability of speech retrieval.

In the application stage of the speech retrieval model of embodiments of the present disclosure, for a text to be synthesized, it is possible to retrieve an optimal pronunciation expression pattern for the text to be synthesized from the speech library because the model has the ability of speech retrieval.

Embodiments of the present disclosure may be implemented to customize historical speech data of a corresponding speaker as a retrieval source according to the requirements of the synthesis task, so as to perform a speech synthesis for a specific person, achieve personalized speech customization needs of users, and improve a speech diversity.

FIG. 6 shows a schematic diagram of a method of training a deep learning model according to an embodiment of the present disclosure.

As shown in FIG. 6, in such embodiments, the deep learning model may be a large language model, and the sample data used for the training of the deep learning model may be a training set of unlabeled speeches. An unlabeled speech has no corresponding text label.

For example, an unlabeled speech may be input into the speech synthesis model, and the speech synthesis model may output a reference speech feature of the unlabeled speech. The speech synthesis model may be trained using finely-labeled speech data, and therefore the reference speech feature output by the speech synthesis model may be accurate and the speech may be synthesized accurately.

For example, the unlabeled speech may be converted into a text as a text to be synthesized, and the text to be synthesized may be input into the speech retrieval model to obtain a pronunciation expression feature of the text. The above-mentioned speech retrieval model may be trained based on coarsely-labeled speech data, and may reconstruct a pronunciation expression pattern of the text to be synthesized based on the speech feature in the speech library.

For example, the pronunciation expression feature output by the speech retrieval model may be input into the deep learning model, and the deep learning model may generate an output speech feature. The parameter of the deep learning model may be adjusted based on a difference between the output speech feature and the reference speech feature, so that the deep learning model may generate an output speech feature consistent with the reference speech feature, and the output speech feature may be used to reconstruct a speech, that is, to synthesize a speech.

The deep learning model is trained using unlabeled speech under the supervision of accurate reference speech feature, which may improve a model training effect and reduce labeling costs.

The above-mentioned reference speech feature is associated with a prosodic feature. The prosodic feature is determined based on the timbre feature and the text feature, and thus contains a timbre information, a speech content and a prosody fluctuation pattern of a speaker. Therefore, in a case of training under the supervision of the reference speech feature, the deep learning model may have a more stable synthesized speech effect in terms of prosody.

The deep learning model of the present disclosure may be a large language model. Different from synthesizing a speech directly based on a text feature using a large language model in the related art, embodiments of the present disclosure may be implemented to, under the supervision of the reference speech feature, determine an output speech feature based on the pronunciation expression feature and synthesize a speech based on the output speech feature, which may improve the speech synthesis effect and effectively improve the problems of missing words, word skipping, and abnormal prosody in speech synthesis.

In addition, different from the method of synthesizing a speech directly based on a text feature using a large language model and improving the synthesis effect by continuous training in the related art, embodiments of the present disclosure use the reference speech feature with high accuracy as the supervision, so that the ability of the large model to reconstruct speech may be improved, the number of training times may be reduced, and costs may also be reduced.

According to embodiments of the present disclosure, the present disclosure further provides a method of synthesizing a speech.

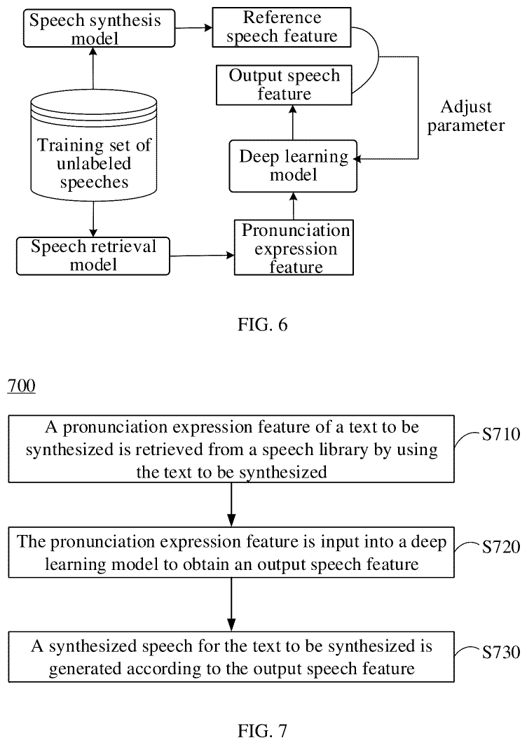

FIG. 7 shows a flowchart of a method of synthesizing a speech according to an embodiment of the present disclosure.

As shown in FIG. 7, a method 700 of synthesizing a speech includes operation S710 to operation S730.

In operation S710, a pronunciation expression feature of a text to be synthesized is retrieved from a speech library by using the text to be synthesized.

For example, if a speech synthesis task is to synthesize a speech with a timbre of a specific person, the speech library may be a database containing historical speeches of the specific person. If a speech synthesis task does not require the speech to be synthesized with a timbre of a specific person, the speech library may be a database containing historical speeches of a plurality of persons. In addition, in an example, if the speech synthesis task is to synthesize a speech with a timbre of a specific person but the historical speech data of the specific person is insufficient, historical speeches of other persons may also be contained. This is because a focus of this step in retrieving the pronunciation expression feature of the sample text is to retrieve the prosodic feature of the pronunciation of that text. If the speech library contains the historical speeches of the same person, the speech of the specific person that is later synthesized may have better timbre and prosody effects.

In an example, a trained speech retrieval model may be used to retrieve the pronunciation expression feature of the text to be synthesized from the speech library. The trained speech retrieval model is trained based on the speech library.

When using the trained speech retrieval model to retrieve the text to be synthesized, it is possible to obtain a cross-attention feature between the text feature and the speech feature in the speech library, and obtain a Mel spectrum feature of the text to be synthesized based on the cross-attention feature. At least one of the attention feature or the Mel spectrum feature may be used as the pronunciation expression feature.

In operation S720, the pronunciation expression feature is input into a deep learning model to obtain an output speech feature.

The deep learning model may be trained according to the above-mentioned method of training the deep learning model, and the training of the deep learning model may be under the supervision of the reference speech feature. The reference speech feature is associated with the prosodic feature and may be used to reconstruct a speech.

The pronunciation expression feature may be input into the trained deep learning model to obtain an output speech feature. The output speech feature is consistent with the reference speech feature and may be used for speech synthesis.

The deep learning model may be a large language model, and the above-mentioned pronunciation expression feature may be input as a prompt information into the large language model to prompt the large language model to generate an output speech feature consistent with the reference speech feature.

In operation S730, a synthesized speech for the text to be synthesized is generated according to the output speech feature.

According to embodiments of the present disclosure, a Mel spectrum feature of the text to be synthesized may be determined according to the output speech feature; and the synthesized speech for the text to be synthesized may be generated according to the Mel spectrum feature of the text to be synthesized.

The output speech feature is consistent with the reference speech feature, and the reference speech feature may be used for speech reconstruction. Therefore, the output speech feature may be converted into a Mel spectrum feature, and the Mel spectrum feature may be converted into a speech, i.e., the synthesized speech for the text to be synthesized.

In embodiments of the present disclosure, the pronunciation expression feature of the text to be synthesized may be retrieved from the speech library, and the pronunciation expression feature may be input into the deep learning model to obtain an output speech feature. As the deep learning model is trained under the supervision of the reference speech feature, the output speech feature obtained by the trained deep learning model is consistent with the reference speech feature, and the accuracy of speech synthesis may be improved in a case of synthesizing a speech using the output speech feature.

According to embodiments of the present disclosure, operation S710 may include: determining a text feature of the text to be synthesized; and retrieving a speech feature in the speech library using the text feature, so as to obtain the pronunciation expression feature. The retrieval may include: performing a cross-attention processing on the text feature and the speech feature in the speech library to obtain an attention feature; determining a Mel spectrum feature of the text to be synthesized according to the attention feature; and determining at least one of the attention feature or the Mel spectrum feature of the text to be synthesized as the pronunciation expression feature.

For example, a trained speech retrieval model may be used to retrieve based on the text feature, a cross-attention processing may be performed on the text feature and the speech feature in the speech library to obtain an attention feature, and a Mel spectrum feature may be determined according to the attention feature. At least one of the attention feature or the Mel spectrum feature may be used as the pronunciation expression feature.

The speech retrieval model is trained based on the speech library. By retrieving using the trained speech retrieval model, it is possible to retrieve an optimal pronunciation expression pattern of the text to be synthesized from the speech library.

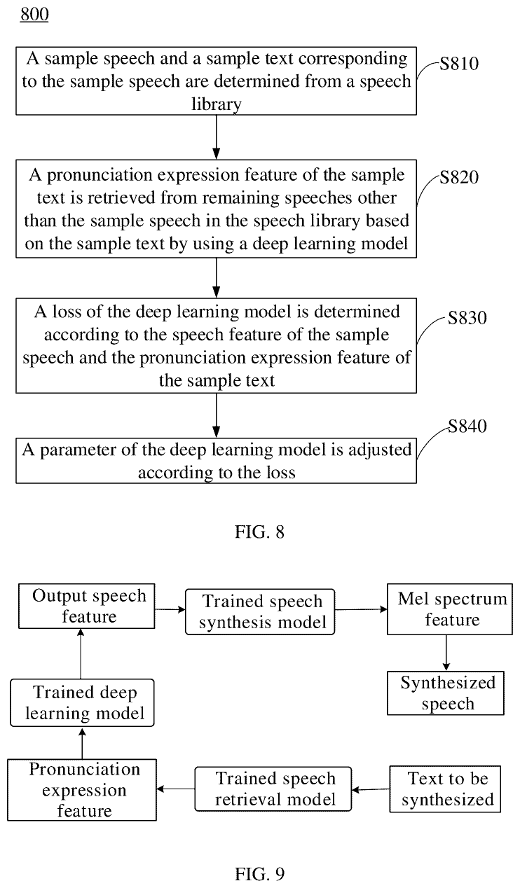

The training of the speech retrieval model provided in the present disclosure will be described below with reference to FIG. 8.

According to embodiments of the present disclosure, the present disclosure further provides another method of training a deep learning model.

FIG. 8 shows a flowchart of a method of training a deep learning model according to another embodiment of the present disclosure.

As shown in FIG. 8, a method 800 of synthesizing a speech includes operation S810 to operation S840.

In operation S810, a sample speech and a sample text corresponding to the sample speech are determined from a speech library.

In such embodiments, the deep learning model may be a speech retrieval model. The speech library may contain a plurality of sample speeches, and each sample speech may be a sentence-level speech. Each sample speech may have a corresponding sample text. In such embodiments, the sample speech and the sample text are used to train the speech retrieval model.

The speech library may be a database containing historical speeches of the same speaker, or a database containing historical speeches of a plurality of speakers. In an example, if a subsequent speech synthesis task is to synthesize a speech with a timbre of a specific person, the speech library may be a database containing historical speeches of the specific person.

In operation S820, a pronunciation expression feature of the sample text is retrieved from remaining speeches other than the sample speech in the speech library based on the sample text by using a deep learning model.

According to embodiments of the present disclosure, a text feature of the sample text may be determined; a cross-attention processing may be performed on the text feature and speech features of the remaining speeches other than the sample speech in the speech library to obtain an attention feature; a Mel spectrum feature of the sample text may be determined according to the attention feature; and at least one of the attention feature or the Mel spectrum feature may be determined as the pronunciation expression feature.

Each sentence of speech in the speech library may be used to train a speech retrieval model. For example, for each sentence of speech (current sentence) in the speech library, during training, the current sentence is removed from a retrieval range of the speech library; with the text of the current sentence as query sentence, and with remaining sentences of speech other than the current speech in the speech library as Key and Value, a cross-attention processing may be performed based on the Key and the Value by using the text of the current sentence, so as to obtain an attention feature between the text feature of the text of the current sentence and the speech features of the remaining sentences of speech. A Mel spectrum feature may be obtained based on the attention feature. A retrieval unit in the above-mentioned retrieval process may be a phoneme or syllable. At least one of the attention feature or the Mel spectrum feature may be used as the pronunciation expression feature.

In operation S830, a loss of the deep learning model is determined according to the speech feature of the sample speech and the pronunciation expression feature of the sample text.

In operation S840, a parameter of the deep learning model is adjusted according to the loss.

According to embodiments of the present disclosure, the pronunciation expression feature is a Mel spectrum feature. Determining the loss of the deep learning model may include: determining a Mel spectrum feature of the sample speech; and determining the loss of the deep learning model according to a difference between the Mel spectrum feature of the sample speech and the pronunciation expression feature.

For example, a difference between the retrieved Mel spectrum feature and a real Mel spectrum feature of the current sentence may be calculated as the loss of the current sentence, and a total loss may be determined according to losses of all sentences in the speech library. A parameter of the speech retrieval model may be adjusted according to the total loss, so as to obtain a trained speech retrieval model.

In the training stage of the speech retrieval model of embodiments of the present disclosure, for each sentence of speech, that sentence of speech may be removed from the retrieval range during training, and the speech retrieval model is forced to learn to reconstruct the speech feature of the current sentence from the remaining sentences in the speech library, so that the model may have the ability of speech retrieval. Using the trained speech retrieval model, it is possible to retrieve an optimal pronunciation expression pattern of the text to be synthesized from the speech library.

FIG. 9 shows a schematic diagram of a method of synthesizing a speech according to an embodiment of the present disclosure.

As shown in FIG. 9, such embodiments include a trained speech retrieval model, a trained deep learning model, and a trained speech synthesis model.

A text to be synthesized may be input into the trained speech retrieval model, and the speech retrieval model may retrieve a pronunciation expression feature of the text to be synthesized from a speech library. The pronunciation expression feature may be input into the trained deep learning model to obtain an output speech feature. The deep learning model is trained under the supervision of the reference speech feature, and therefore the output speech feature is consistent with the reference speech feature.

The reference speech feature is associated with a prosodic feature. A Mel spectrum feature may be obtained based on the prosodic feature, and the Mel spectrum feature may be used for speech reconstruction. The output speech feature consistent with the reference speech feature may be input into the trained speech synthesis model to obtain the Mel spectrum feature. The Mel spectrum feature may be converted into a speech, i.e., a synthesized speech for the text to be synthesized.

In embodiments of the present disclosure, the pronunciation expression feature of the text to be synthesized may be retrieved using the trained speech retrieval model, and the pronunciation expression feature may be input into the trained deep learning model to obtain an output speech feature. As the output speech feature is consistent with the reference speech feature and may be used for speech reconstruction, the trained speech synthesis model may be used to reconstruct a speech based on the output speech feature, that is, to synthesize a speech for the text to be synthesized. As the reference speech feature is associated with a prosodic feature, the synthesized speech has high stability in terms of prosody.

According to embodiments of the present disclosure, the present disclosure further provides an apparatus of training a deep learning model, an apparatus of synthesizing a speech, and another apparatus of training a deep learning model.

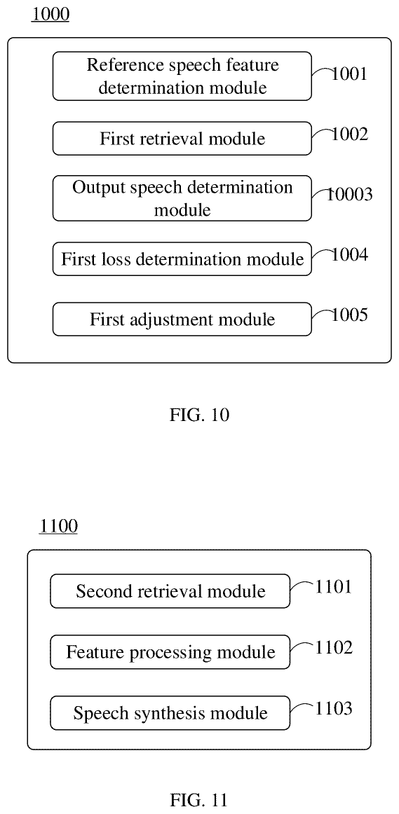

FIG. 10 shows a block diagram of an apparatus of training a deep learning model according to an embodiment of the present disclosure.

As shown in FIG. 10, an apparatus 1000 of training a deep learning model includes a reference speech feature determination module 1001, a first retrieval module 1002, an output speech determination module 1003, a first loss determination module 1004, and a first adjustment module 1005.

The reference speech feature determination module 1001 may be used to determine a reference speech feature of a sample speech, where the reference speech feature is associated with a prosodic feature of the sample speech.

The first retrieval module 1002 may be used to retrieve a speech library using a sample text corresponding to the sample speech, so as to obtain a pronunciation expression feature of the sample text.

The output speech determination module 1003 may be used to input the pronunciation expression feature into the deep learning model to obtain an output speech feature.

The first loss determination module 1004 may be used to determine a loss of the deep learning model according to the reference speech feature and the output speech feature.

The first adjustment module 1005 may be used to adjust a parameter of the deep learning model according to the loss.

FIG. 11 shows a block diagram of an apparatus of synthesizing a speech according to an embodiment of the present disclosure.

As shown in FIG. 11, an apparatus 1100 of synthesizing a speech includes a second retrieval module 1101, a feature processing module 1102, and a speech synthesis module 1103.

The second retrieval module 1101 may be used to retrieve a pronunciation expression feature of a text to be synthesized from a speech library by using the text to be synthesized.

The feature processing module 1102 may be used to input the pronunciation expression feature into a deep learning model to obtain an output speech feature, where the deep learning model is trained according to the above-mentioned apparatus of training the deep learning model.

The speech synthesis module 1103 may be used to generate a synthesized speech for the text to be synthesized according to the output speech feature.

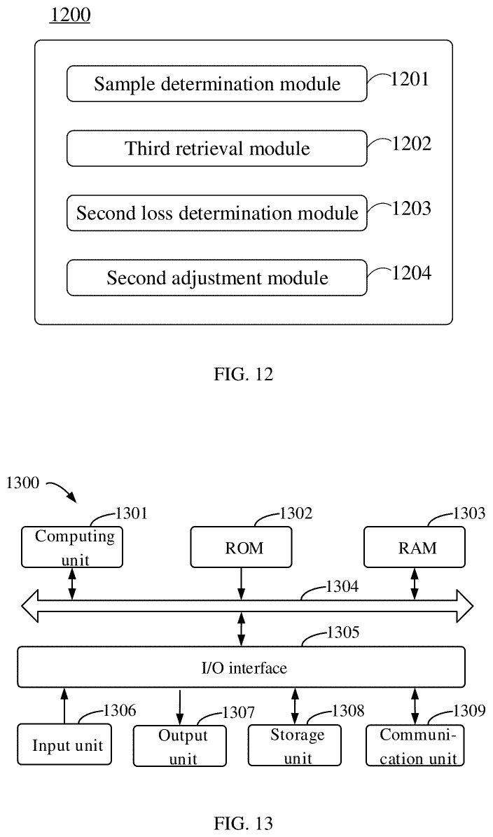

FIG. 12 shows a block diagram of an apparatus of training a deep learning model according to another embodiment of the present disclosure.

As shown in FIG. 12, an apparatus 1200 of training a deep learning model includes a sample determination module 1201, a third retrieval module 1202, a second loss determination module 1203, and a second adjustment module 1204.

The sample determination module 1201 may be used to determine, from a speech library, a sample speech and a sample text corresponding to the sample speech.

The third retrieval module 1202 may be used to retrieve a pronunciation expression feature of the sample text from remaining speeches other than the sample speech in the speech library based on the sample text by using a deep learning model.

The second loss determination module 1203 may be used to determine a loss of the deep learning model according to the speech feature of the sample speech and the pronunciation expression feature of the sample text.

The second adjustment module 1204 may be used to adjust a parameter of the deep learning model according to the loss.

According to embodiments of the present disclosure, the present disclosure further provides an electronic device, a readable storage medium, and a computer program product.

FIG. 13 shows a schematic block diagram of an example electronic device 1300 for implementing embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 13, the electronic device 1300 includes a computing unit 1301 which may perform various appropriate actions and processes according to a computer program stored in a read only memory (ROM) 1302 or a computer program loaded from a storage unit 1308 into a random access memory (RAM) 1303. In the RAM 1303, various programs and data necessary for an operation of the electronic device 1300 may also be stored. The computing unit 1301, the ROM 1302 and the RAM 1303 are connected to each other through a bus 1304. An input/output (I/O) interface 1305 is also connected to the bus 1304.

A plurality of components in the electronic device 1300 are connected to the I/O interface 1305, including: an input unit 1306, such as a keyboard, or a mouse; an output unit 1307, such as displays or speakers of various types; a storage unit 1308, such as a disk, or an optical disc; and a communication unit 1309, such as a network card, a modem, or a wireless communication transceiver. The communication unit 1309 allows the electronic device 1300 to exchange information/data with other devices through a computer network such as Internet and/or various telecommunication networks.

The computing unit 1301 may be various general-purpose and/or dedicated processing assemblies having processing and computing capabilities. Some examples of the computing unit 1301 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 1301 executes various methods and processes described above, such as at least one selected from the method of training the deep learning model, the method of synthesizing the speech, or the another method of training the deep learning model. For example, in some embodiments, at least one selected from the method of training the deep learning model, the method of synthesizing the speech, or the another method of training the deep learning model may be implemented as a computer software program which is tangibly embodied in a machine-readable medium, such as the storage unit 1308. In some embodiments, the computer program may be partially or entirely loaded and/or installed in the electronic device 1300 via the ROM 1302 and/or the communication unit 1309. The computer program, when loaded in the RAM 1303 and executed by the computing unit 1301, may execute one or more steps in at least one selected from the method of training the deep learning model, the method of synthesizing the speech, or the another method of training the deep learning model described above. Alternatively, in other embodiments, the computing unit 1301 may be used to perform at least one selected from the method of training the deep learning model, the method of synthesizing the speech, or the another method of training the deep learning model by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, speech input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of training a deep learning model, comprising:
determining a reference speech feature of a sample speech, wherein the reference speech feature is associated with a prosodic feature of the sample speech;
retrieving a speech library using a sample text corresponding to the sample speech, so as to obtain a pronunciation expression feature of the sample text;
inputting the pronunciation expression feature into the deep learning model to obtain an output speech feature;
determining a loss of the deep learning model according to the reference speech feature and the output speech feature; and
adjusting a parameter of the deep learning model according to the loss.

2. The method according to claim 1, wherein the determining a reference speech feature of a sample speech comprises:
determining the prosodic feature and/or a Mel spectrum feature of the sample speech as the reference speech feature,
wherein the prosodic feature is determined according to the sample speech and the sample text, and the Mel spectrum feature of the sample speech is determined according to the prosodic feature.

3. The method according to claim 2, further comprising:
determining a timbre feature of the sample speech;
determining a text feature of the sample text; and
determining a prosodic feature of the sample text according to the timbre feature and the text feature.

4. The method according to claim 3, further comprising:
determining the Mel spectrum feature of the sample speech according to the timbre feature, the text feature and the prosodic feature.

5. The method according to claim 1, wherein the retrieving a speech library using a sample text corresponding to the sample speech so as to obtain a pronunciation expression feature of the sample text comprises:
determining a text feature of the sample text; and
retrieving a speech feature in the speech library by using the text feature, so as to obtain the pronunciation expression feature.

6. The method according to claim 5, wherein the retrieving a speech feature in the speech library by using the text feature so as to obtain the pronunciation expression feature comprises:
performing a cross-attention processing on the text feature and the speech feature in the speech library to obtain an attention feature;
determining a Mel spectrum feature of the sample text according to the attention feature; and
determining the attention feature and/or the Mel spectrum feature of the sample text as the pronunciation expression feature.

7. The method according to claim 1, wherein the deep learning model is a large language model, and the inputting the pronunciation expression feature into the deep learning model to obtain an output speech feature comprises:
inputting the pronunciation expression feature as a prompt information into the large language model, so as to prompt the large language model to generate the output speech feature.

8. A method of synthesizing a speech, comprising:
retrieving, from a speech library, a pronunciation expression feature of a text to be synthesized by using the text to be synthesized;
inputting the pronunciation expression feature into a deep learning model to obtain an output speech feature, wherein the deep learning model is trained according to the method of claim 1; and
generating a synthesized speech for the text to be synthesized according to the output speech feature.

9. The method according to claim 8, wherein the retrieving, from a speech library, a pronunciation expression feature of a text to be synthesized by using the text to be synthesized comprises:
determining a text feature of the text to be synthesized; and
retrieving a speech feature in the speech library by using the text feature, so as to obtain the pronunciation expression feature.

10. The method according to claim 9, wherein the retrieving a speech feature in the speech library by using the text feature so as to obtain the pronunciation expression feature comprises:
performing a cross-attention processing on the text feature and the speech feature in the speech library to obtain an attention feature;
determining a Mel spectrum feature of the text to be synthesized according to the attention feature; and
determining the attention feature and/or the Mel spectrum feature of the text to be synthesized as the pronunciation expression feature.

11. The method according to claim 8, wherein the deep learning model is a large language model, and the inputting the pronunciation expression feature into a deep learning model to obtain an output speech feature comprises:
inputting the pronunciation expression feature as a prompt information into the large language model, so as to prompt the large language model to generate the output speech feature.

12. The method according to claim 8, wherein the generating a synthesized speech for the text to be synthesized according to the output speech feature comprises:
determining a Mel spectrum feature of the text to be synthesized according to the output speech feature; and
generating the synthesized speech for the text to be synthesized according to the Mel spectrum feature of the text to be synthesized.

13. A method of training a deep learning model, comprising:
determining, from a speech library, a sample speech and a sample text corresponding to the sample speech;
retrieving, from remaining speeches other than the sample speech in the speech library, a pronunciation expression feature of the sample text based on the sample text by using the deep learning model;
determining a loss of the deep learning model according to a speech feature of the sample speech and the pronunciation expression feature of the sample text; and
adjusting a parameter of the deep learning model according to the loss.

14. The method according to claim 13, wherein the retrieving, from remaining speeches other than the sample speech in the speech library, a pronunciation expression feature of the sample text based on the sample text by using the deep learning model comprises:
determining a text feature of the sample text;
performing a cross-attention processing on the text feature and speech features of the remaining speeches other than the sample speech in the speech library to obtain an attention feature;
determining a Mel spectrum feature of the sample text according to the attention feature; and
determining the attention feature and/or the Mel spectrum feature as the pronunciation expression feature.

15. The method according to claim 14, wherein the pronunciation expression feature is the Mel spectrum feature, and the determining a loss of the deep learning model according to a speech feature of the sample speech and the pronunciation expression feature of the sample text comprises:
determining a Mel spectrum feature of the sample speech; and
determining the loss of the deep learning model according to a difference between the Mel spectrum feature of the sample speech and the pronunciation expression feature.

16. An electronic device, comprising:
at least one processor; and
a memory communicatively connected to the at least one processor, wherein the memory stores instructions executable by the at least one processor, and the instructions, when executed by the at least one processor, are configured to cause the at least one processor to at least:
determine a reference speech feature of a sample speech, wherein the reference speech feature is associated with a prosodic feature of the sample speech;
retrieve a speech library using a sample text corresponding to the sample speech, so as to obtain a pronunciation expression feature of the sample text;
input the pronunciation expression feature into the deep learning model to obtain an output speech feature;
determine a loss of the deep learning model according to the reference speech feature and the output speech feature; and
adjust a parameter of the deep learning model according to the loss.

17. An electronic device, comprising:
at least one processor; and
a memory communicatively connected to the at least one processor, wherein the memory stores instructions executable by the at least one processor, and the instructions, when executed by the at least one processor, are configured to cause the at least one processor to implement the method of claim 8.

18. An electronic device, comprising:
at least one processor; and
a memory communicatively connected to the at least one processor, wherein the memory stores instructions executable by the at least one processor, and the instructions, when executed by the at least one processor, are configured to cause the at least one processor to implement the method of claim 13.

19. A non-transitory computer-readable storage medium having computer instructions therein, wherein the computer instructions are configured to cause a computer to implement the method of claim 1.

20. A non-transitory computer-readable storage medium having computer instructions therein, wherein the computer instructions are configured to cause a computer to implement the method of claim 8.
